(19) United States
(12) Patent Application Publication
(10) Pub. No.: US 2024/0373210 A1
(43) Pub. Date: Nov. 7, 2024

(54) COMMUNICATION METHOD AND COMMUNICATIONS APPARATUS

(71) Applicant: GUANGDONG OPPO MOBILE TELECOMMUNICATIONS CORP, LTD., Dongguan (CN)

(72) Inventors: Chuanfeng HE, Dongguan (CN); Zhisong ZUO, Dongguan (CN); Weijie XU, Dongguan (CN); Shengjiang CUI, Dongguan (CN)

(73) Assignee: GUANGDONG OPPO MOBILE TELECOMMUNICATIONS CORP, LTD., Dongguan (CN)

(21) Appl. No.: 18/777,344

(22) Filed: Jul. 18, 2024

Related U.S. Application Data
(63) Continuation of application No. PCT/CN2022/090180, filed on Apr. 29, 2022.

(51) Int. Cl. H04W 8/24; H04W 48/08; H04W 48/20

(52) U.S. Cl. CPC H04W 8/24; H04W 48/08; H04W 48/20

(57) ABSTRACT

A communication method and a communications apparatus are provided. The method includes: receiving, by a terminal device, first information sent by a network device, where the first information is used to indicate whether a reduced capability (RedCap) terminal device with a first bandwidth capability is allowed to select or reselect a cell corresponding to the network device; and determining, by the terminal device based on the first information, whether to select or reselect the cell.

### CROSS-REFERENCE TO RELATED APPLICATIONS

This application is a continuation of International Application No. PCT/CN2022/090180, filed on Apr. 29, 2022, the disclosure of which is hereby incorporated by reference in its entirety.

### TECHNICAL FIELD

This application relates to the field of communications technologies, and more specifically, to a communication method and a communications apparatus.

### BACKGROUND

With development of communications technologies, reduced capability (RedCap) terminal devices are put into use in some communications systems, and the RedCap terminal device has features such as a large quantity of connections, low power consumption, and low costs. However, because the RedCap terminal device usually has a relatively large quantity of connections, another problem may be introduced during use.

### SUMMARY

Embodiments of this application provide a communication method and a communications apparatus. Various aspects used in the embodiments of this application are described below.

According to a first aspect, a communication method is provided, including: receiving, by a terminal device, first information transmitted by a network device, where the first information is used to indicate whether a reduced capability RedCap terminal device with a first bandwidth capability is allowed to select or reselect a cell corresponding to the network device; and determining, by the terminal device based on the first information, whether to select or reselect the cell.

According to a second aspect, a communication method is provided, including: transmitting, by a network device, first information to a terminal device, where the first information is used to indicate whether a reduced capability RedCap terminal device with a first bandwidth capability is allowed to select or reselect a cell corresponding to the network device.

According to a third aspect, a communications apparatus is provided, including: a receiving unit, configured to receive first information transmitted by a network device, where the first information is used to indicate whether a reduced capability RedCap terminal device with a first bandwidth capability is allowed to select or reselect a cell corresponding to the network device; and a determining unit, configured to determine, based on the first information, whether to select or reselect the cell.

According to a fourth aspect, a communications apparatus is provided, including: a transmitting unit, configured to transmit first information to a terminal device, where the first information is used to indicate whether a reduced capability RedCap terminal device with a first bandwidth capability is allowed to select or reselect a cell corresponding to the apparatus.

According to a fifth aspect, a communications apparatus is provided, including a memory, a transceiver, and a processor, where the memory is configured to store a program, the processor receives and transmits data through the transceiver, and the processor is configured to invoke the program in the memory, to cause the terminal device to perform the method according to the first aspect.

According to a sixth aspect, a communications apparatus is provided, including a memory, a transceiver, and a processor, where the memory is configured to store a program, the processor receives and transmits data through the transceiver, and the processor is configured to invoke the program in the memory, to cause the terminal device to perform the method according to the second aspect.

According to a seventh aspect, a communications apparatus is provided, including a processor configured to invoke a program from a memory, to cause the terminal device to perform the method according to the first aspect.

According to an eighth aspect, a communications apparatus is provided, including a processor configured to invoke a program from a memory, to cause the terminal device to perform the method according to the second aspect.

According to a ninth aspect, a chip is provided, including a processor, configured to invoke a program from a memory, to cause a device on which the chip is installed to perform the method according to the first aspect.

According to a tenth aspect, a chip is provided, including a processor, configured to invoke a program from a memory, to cause a device on which the chip is installed to perform the method according to the second aspect.

According to an eleventh aspect, a computer-readable storage medium is provided, storing a program, where the program causes a computer to perform the method according to the first aspect.

According to a twelfth aspect, a computer-readable storage medium is provided, storing a program, where the program causes a computer to perform the method according to the second aspect.

According to a thirteenth aspect, a computer program product is provided, including a program, where the program causes a computer to perform the method according to the first aspect.

According to a fourteenth aspect, a computer program product is provided, including a program, where the program causes a computer to perform the method according to the second aspect.

According to a fifteenth aspect, a computer program is provided, where the computer program causes a computer to perform the method according to the first aspect.

According to a sixteenth aspect, a computer program is provided, where the computer program causes a computer to perform the method according to the second aspect.

### BRIEF DESCRIPTION OF DRAWINGS

FIG. 1 is an example diagram of a wireless communications system to which an embodiment of this application is applied.

FIG. 2 is a schematic flowchart of a communication method according to an embodiment of this application.

FIG. 3 is a schematic structural diagram of a communications apparatus according to an embodiment of this application.

FIG. 4 is a schematic structural diagram of a communications apparatus according to another embodiment of this application.

FIG. 5 is a schematic structural diagram of an apparatus according to an embodiment of this application.

### DESCRIPTION OF EMBODIMENTS

Technical solutions in this application are described below with reference to the accompanying drawings.

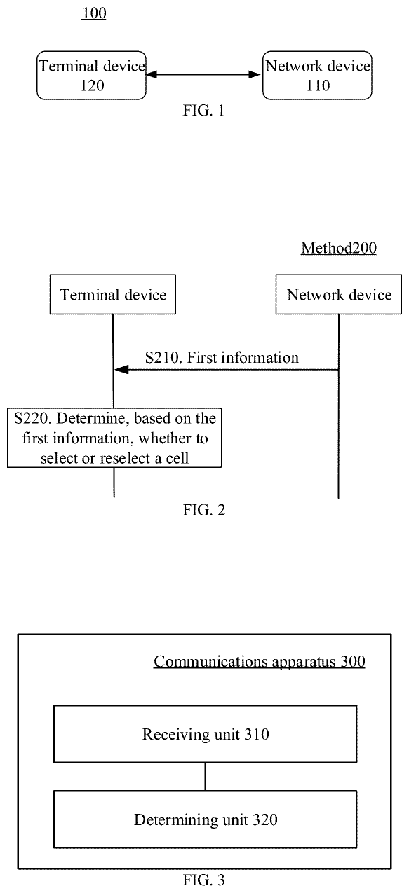

FIG. 1 shows a structure of a wireless communications system 100 to which an embodiment of this application is applied. The structure shown in FIG. 1 includes a network device 110 and a terminal device 120. The network device 110 may be a device that communicates with the terminal device 120. The network device 110 may provide communication coverage for a specific geographic area, and may communicate with the terminal device 120 located within the coverage.

It should be noted that FIG. 1 exemplarily shows one network device and one terminal device. Optionally, the communications system 100 may include a plurality of network devices, and another quantity of terminal devices may be included within coverage of each network device. This is not limited in embodiments of this application.

In addition, in some implementations, the communications system 100 may further include another network entity such as a network controller or a mobility management entity. This is not limited in embodiments of this application.

It should be understood that the technical solutions of embodiments of this application may be applied to various communications systems, such as a 5th generation (5G) system or new radio (NR), a long term evolution (long term evolution, LTE) system, an LTE frequency division duplex (FDD) system, LTE time division duplex (TDD), and a cellular Internet of Things. The technical solutions provided in this application may further be applied to a future communications system, for example, a 6th generation mobile communications system.

The terminal device in embodiments of this application may also be referred to as a user equipment (UE), an access terminal, a subscriber unit, a subscriber station, a mobile, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device, an in-vehicle device, a household appliance, a sensor, and an electronic tag having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, or the like.

The network device in embodiments of this application may be a device configured to communicate with the terminal device. If the terminal device is the electronic tag, the network device may be a reader/writer for reading and writing the electronic tag (for example, a reader/writer based on radio frequency identification (RFID) technology). The network device may alternatively be an access network device or a radio access network device. For example, the network device may be a base station. The network device in embodiments of this application may be a radio access network (RAN) node (or device) that connects the terminal device to a wireless network. The base station may broadly cover the following various names, or may be replaced with the following names, such as a NodeB, an evolved NodeB (eNB), a next generation NodeB (gNB), a relay station, an access point, a transmitting and receiving point (TRP), a transmitting point (TP), a master eNode MeNB, a secondary eNode SeNB, a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device (D2D), vehicle-to-everything (V2X), and machine-to-machine (M2M) communication, a network-side device in a 6G network, a device that functions as a base station in a future communications system, or the like. The base station may support networks of a same access technology or different access technologies. A specific technology and a specific device form used by the network device are not limited in embodiments of this application.

In some embodiments, the network device may be fixed or mobile. For example, a helicopter or an unmanned aerial vehicle may be configured to serve as a mobile base station, and one or more cells may move according to a location of the mobile base station. In other examples, a helicopter or an unmanned aerial vehicle may be configured to serve as a device in communication with another base station.

In some deployments, the network device in embodiments of this application may be a CU or a DU, or the network device includes a CU and a DU. A gNB may further include an AAU.

The network device and the terminal device may be deployed on land, including being indoors or outdoors, handheld, or in-vehicle, may be deployed on a water surface, or may be deployed on a plane, a balloon, or a satellite in the air. In embodiments of this application, a scenario in which the network device and the terminal device are located is not limited.

It should be understood that all or some of functions of the network device and the terminal device in this application may also be implemented by software functions running on hardware, or by virtualization functions instantiated on a platform (for example, a cloud platform).

To avoid network congestion, an operator may control access of the terminal device in a cell camping phase. For example, when congestion occurs on a network, the network may bar some terminals from camping on a current cell, so that random access congestion caused by a random access process initiated by such a terminal device may be avoided earlier.

In the NR system, master information block (MIB) information carried in a physical broadcast channel (PBCH) includes a 1-bit cellBarred information field, and the cellBarred information field is used to indicate that a cell allows or bars access. After the terminal device detects a synchronization signal/PBCH Block (SSB) in a cell search phase, and reads MIB information in the SSB, it may be determined, based on a cellBarred information field in the MIB information, whether to access the cell.

With development of communications technologies, reduced capability (RedCap) terminal devices are introduced into some communications systems, and the RedCap terminal device has features such as a large quantity of connections, low power consumption, and low costs.

Currently, based on different capabilities of terminal devices (such as a supported maximum bandwidth and an antenna quantity), there may be a plurality of types of RedCap terminal devices.

For example, based on different quantities of receive antennas, the RedCap terminal devices may be classified into a single receive antenna (1Rx) terminal device and a double receive antenna (2Rx) terminal device.

For another example, in a standard protocol of some releases (for example, a release 17 (R17)) of a 3rd generation partnership project (3GPP), a maximum bandwidth supported by the RedCap terminal device is reduced to 20 MHz on a frequency range 1 (FR 1), and a maximum bandwidth supported by the RedCap terminal device is reduced to 100 MHz on a frequency range 2 (FR 2). To further reduce costs, power consumption, and complexity of the RedCap terminal device, it is considered in some other releases of the 3GPP (for example, in a standard protocol of an R18) that a maximum bandwidth supported by the RedCap terminal device is further reduced to 5 MHz on the FR 1.

However, a quantity of connections of the RedCap terminal device is often relatively large, and network congestion is prone to occur. Currently, it is only supported that access control is separately performed on a 1Rx RedCap terminal device and a 2Rx RedCap terminal device, and no finer control can be performed based on a bandwidth capability.

To resolve one or more of the foregoing technical problems, this application proposes a communication method and a communications apparatus. In embodiments of this application, the terminal device determines, based on first information, whether to select or reselect a cell, so that access control can be performed on a RedCap terminal device with a specific bandwidth capability, to implement finer access control, so that utilization of network resources can be increased, and network congestion and a decrease in a network throughput are avoided.

The following exemplarily describes embodiments of this application in detail with reference to FIG. 2.

FIG. 2 is a schematic flowchart of a communication method according to an embodiment of this application. The method 200 shown in FIG. 2 may include steps S210 and S220. Details are as follows.

S210: A network device transmits first information. Correspondingly, a terminal device receives the first information.

The first information may be used to indicate whether a reduced capability RedCap terminal device with a first bandwidth capability is allowed to select or reselect a cell corresponding to the network device. The cell corresponding to the network device herein may refer to a cell in which the network device provides a service. Therefore, the cell corresponding to the network device may alternatively be understood as a serving cell of the network device. Optionally, after selecting or reselecting the cell, the terminal device may access the cell, for example, perform random access.

The first information may be carried in a system message. For example, the first information may be carried in a system information block 1 (SIB 1).

In some possible implementations, the first bandwidth capability may indicate a maximum bandwidth supported by the RedCap terminal device.

The first bandwidth capability may include: the supported maximum bandwidth is a first bandwidth. For example, for an FR1, the first bandwidth may be 5 MHz, and for an FR2, the first bandwidth may be 20 MHz or 50 MHz.

For example, the first information may indicate that a RedCap terminal device whose supported maximum bandwidth is a first bandwidth is not allowed to select or reselect the cell.

Alternatively, the first information may indicate that a RedCap terminal device whose supported maximum bandwidth is a first bandwidth is allowed to select or reselect the cell. It should be noted that allowing a RedCap terminal device whose supported maximum bandwidth is a first bandwidth to select or reselect the cell may be understood as: selecting or reselecting the cell is allowed based on this signalling, but does not mean that the terminal device may select or reselect the cell at this moment (when this condition is met). The terminal device further needs to determine, based on another preset condition (for example, another condition, for determining whether a cell is barred, specified in the protocol TS38.304), whether the terminal device can select or reselect the cell.

In some possible implementations, the first bandwidth capability may indicate a maximum bandwidth supported by the RedCap terminal device and a quantity of receive antennas.

Optionally, the first bandwidth capability may further include: a first quantity of receive antennas. Optionally, the first quantity may be 1 or 2.

For example, the first information may be used to indicate that a RedCap terminal device whose supported maximum bandwidth is a first bandwidth and that has a first quantity of receive antennas is not allowed to select or reselect the cell.

Alternatively, the first information may be used to indicate that a RedCap terminal device whose supported maximum bandwidth is a first bandwidth and that has a first quantity of receive antennas is allowed to select or reselect the cell.

S220: The terminal device determines, based on the first information, whether to select or reselect the cell.

Optionally, if the terminal device is the RedCap terminal device with the first bandwidth capability, the terminal device may not select or reselect the cell; otherwise, the terminal device is allowed to select or reselect the cell.

For example, the first information indicates that the RedCap terminal device whose supported maximum bandwidth is the first bandwidth is not allowed to select or reselect the cell. If the terminal device is the RedCap terminal device whose supported maximum bandwidth is the first bandwidth, the terminal device does not select or reselect the cell; otherwise, the terminal device is allowed to select or reselect the cell. In this case, the terminal device further needs to determine, based on another preset condition, whether the terminal device can select or reselect the cell.

For another example, the first information indicates that the RedCap terminal device whose supported maximum bandwidth is the first bandwidth is allowed to select or reselect the cell. If the terminal device is not the RedCap terminal device whose supported maximum bandwidth is the first bandwidth, the terminal device does not select or reselect the cell; otherwise, the terminal device is allowed to select or reselect the cell. In this case, the terminal device further needs to determine, based on another preset condition, whether the terminal device can select or reselect the cell.

For another example, the first information indicates that the RedCap terminal device whose supported maximum bandwidth is the first bandwidth and that has the first quantity of receive antennas is not allowed to select or reselect the cell. If the terminal device is the RedCap terminal device whose supported maximum bandwidth is the first bandwidth and that has the first quantity of receive antennas, the terminal device does not select or reselect the cell; otherwise, the terminal device is allowed to select or reselect the cell. In this case, the terminal device further needs to determine, based on another preset condition, whether the terminal device can select or reselect the cell.

Alternatively, the first information may be used to indicate that the RedCap terminal device whose supported maximum bandwidth is the first bandwidth and that has the first quantity of receive antennas is allowed to select or reselect the cell. If the terminal device is not the RedCap terminal device whose supported maximum bandwidth is the first bandwidth and that has the first quantity of receive antennas, the terminal device does not select or reselect the cell; otherwise, the terminal device is allowed to select or reselect the cell. In this case, the terminal device further needs to determine, based on another preset condition, whether the terminal device can select or reselect the cell.

Further, the first information may further indicate whether a reduced capability RedCap terminal device with a second bandwidth capability is allowed to select or reselect a cell corresponding to the network device.

Optionally, the second bandwidth capability may include: the supported maximum bandwidth is a second bandwidth. For example, for an FR1, the second bandwidth may be 10 MHz or 20 MHz, and for an FR2, the second bandwidth may be 100 MHz.

Optionally, the second bandwidth capability may further include: a second quantity of receive antennas. Optionally, the second quantity may be 1 or 2.

In this case, whether the terminal device selects or reselects the cell may be determined based on the second bandwidth capability. For example, if the terminal device is the RedCap terminal device with the first bandwidth capability, the terminal device may not select or reselect the cell; otherwise, the terminal device is allowed to select or reselect the cell.

In embodiments of this application, the first information is used to indicate whether the reduced capability RedCap terminal device with the first bandwidth capability is allowed to select or reselect the cell. The terminal device determines, based on the first information, whether to select or reselect the cell. In this case, access control can be performed on a RedCap terminal device with a specific bandwidth capability, to implement finer access control, so that utilization of network resources can be increased, and network congestion and a decrease in a network throughput are avoided.

The foregoing solution is described below in detail with reference to two embodiments.

For example, two pieces of information cellBarredRedCapBW1 and cellBarredRedCapBW2 may be added to the SIB1, where cellBarredRedCapBW1 may indicate whether to allow access of the RedCap terminal device having the first bandwidth capability (the supported maximum bandwidth is BW1), and the cellBarredRedCapBW2 may indicate whether to allow access of the RedCap terminal device having the second bandwidth capability (the supported maximum bandwidth is BW2).

For an FR1, BW1 corresponding to the first bandwidth capability may be 5 MHz, and BW2 corresponding to the second bandwidth capability may be 10 MHz or 20 MHz; for an FR2, BW1 corresponding to the first bandwidth capability may be 20 MHz or 50 MHz, and BW2 corresponding to the second bandwidth capability may be 100 MHz. It should be noted that BW1 and BW2 herein are only examples and are not limited in embodiments of this application. A specific signalling format may be as follows:

```
cellBarredRedCap-r18 SEQUENCE{
  cellBarredRedCapBW1-r18 ENUMERATED{barred, notBarred},
  cellBarredRedCapBW2-r18 ENUMERATED{barred, notBarred}
}
```

Optionally, whether the RedCap terminal device can access the cell may be determined in combination with an existing determining condition and access control information corresponding to the bandwidth capability of the RedCap terminal device. A process of determining whether the cell may be accessed may be shown as follows:
(1) If a UE is a RedCap UE, when ssb-SubcarrierOffset information in a MIB indicates SIB1 transmission in the cell, the SIB1 information may be obtained.
(2) If no intraFreqReselectionRedCap exists in the SIB1 information, the cell is barred (that is, it is not allowed to access the cell); otherwise, the following steps may be performed.
(3) If cellBarredRedCap1Rx exists in the SIB1 information and is set to be barred, and the UE is a RedCap UE with 1Rx, the cell is barred.
(4) If cellBarredRedCap2Rx exists in the SIB1 information and is set to be barred, and the UE is a RedCap UE with 2Rx, the cell is barred.
(5) If no halfDuplexRedCapAllowed exists in the SIB1 information and the UE supports only a half-duplex FDD operation, the cell is barred.
(6) If cellBarredRedCapBW1 exists in the SIB1 information and is set to be barred, and the UE is a RedCap UE whose supported maximum bandwidth is 5 MHz, the cell is barred.
(7) If cellBarredRedCapBW2 exists in the SIB1 information and is set to be barred, and the UE is a RedCap UE whose supported maximum bandwidth is 20 MHz, the cell is barred.
(8) Otherwise, whether the cell is barred may be continuously determined according to another preset condition specified in a protocol TS38.304.

All of ssb-SubcarrierOffset, intraFreqReselectionRedCap, cellBarredRedCap1Rx, cellBarredRedCap2Rx, and halfDuplexRedCapAllowed are information defined in a conventional technology. For specific meanings, refer to definitions in the conventional technology. Details are not described herein.

For another example, two pieces of information cellBarredRedCapBW1Rx and cellBarredRedCapBW2Rx may be added to the SIB1, where cellBarredRedCapBW1Rx may indicate whether to allow access of the RedCap terminal device having the first bandwidth capability (the supported maximum bandwidth is BW) and 1Rx, and the cellBarredRedCapBW2Rx may indicate whether to allow access of the RedCap terminal device having the first bandwidth capability BW and 2Rx.

For an FR1, BW corresponding to the first bandwidth capability may be 5 MHz, 10 MHz, or the like, and for an FR2, BW corresponding to the first bandwidth capability may be 20 MHz, 50 MHz, or the like. It should be noted that BW herein is only an example and is not limited in embodiments of this application. A specific signalling format may be as follows:

```
cellBarredRedCap-r18 SEQUENCE{
  cellBarredRedCapBW1Rx-r18 ENUMERATED{barred, notBarred},
  cellBarredRedCapBW2Rx-r18 ENUMERATED{barred, notBarred}
}
```

Optionally, whether the RedCap terminal device can access the cell may be determined in combination with an existing determining condition and access control information corresponding to the bandwidth capability of the RedCap terminal device. A process of determining whether the cell may be accessed may be shown as follows:
(1) If a UE is a RedCap UE, when ssb-SubcarrierOffset information in a MIB indicates SIB1 transmission in the cell, the SIB1 information may be obtained.
(2) If no intraFreqReselectionRedCap exists in the SIB1 information, the cell is barred; otherwise, the following steps may be performed.
(3) If cellBarredRedCap1Rx exists in the SIB1 information and is set to be barred, and the UE is a RedCap UE with 1Rx and the first bandwidth capability, the cell is barred.
(4) If cellBarredRedCap2Rx exists in the SIB1 information and is set to be barred, and the UE is a RedCap UE with 2Rx and the first bandwidth capability, the cell is barred.
(5) If no halfDuplexRedCapAllowed exists in the SIB1 information and the UE supports only a half-duplex FDD operation, the cell is barred.
(6) If cellBarredRedCapBW1Rx exists in the SIB1 information and is set to be barred, and the UE is a RedCap UE with 1Rx and the first bandwidth capability, the cell is barred.
(7) If cellBarredRedCapBW2Rx exists in the SIB1 information and is set to be barred, and the UE is a RedCap UE with 2Rx and the first bandwidth capability, the cell is barred.
(8) Otherwise, whether the cell is barred may be continuously determined according to another preset condition specified in a protocol TS38.304.

The method embodiments of this application are described above in detail with reference to FIG. 1 and FIG. 2. Apparatus embodiments of this application are described below in detail with reference to FIG. 3 to FIG. 5. It should be understood that the descriptions of the method embodiments correspond to descriptions of the apparatus embodiments, and therefore, for parts that are not described in detail, reference may be made to the foregoing method embodiments.

FIG. 3 is a schematic structural diagram of a communications apparatus according to an embodiment of this application. As shown in FIG. 3, the apparatus 300 specifically includes:
a receiving unit 310, configured to receive first information sent by a network device, where the first information is used to indicate whether a reduced capability RedCap terminal device with a first bandwidth capability is allowed to select or reselect a cell corresponding to the network device; and
a determining unit 320, configured to determine, based on the first information, whether to select or reselect the cell.

Optionally, the first bandwidth capability includes: a supported maximum bandwidth is a first bandwidth.

Optionally, the first bandwidth capability further includes: a first quantity of receive antennas.

Optionally, the first information is configured to indicate that a RedCap terminal device whose supported maximum bandwidth is a first bandwidth is not allowed to select or reselect the cell.

Optionally, the first information configured to indicate that a RedCap terminal device whose supported maximum bandwidth is a first bandwidth is allowed to select or reselect the cell.

Optionally, the first information is used to indicate that a RedCap terminal device whose supported maximum bandwidth is a first bandwidth and that has a first quantity of receive antennas is not allowed to select or reselect the cell.

Optionally, the first information is used to indicate that a RedCap terminal device whose supported maximum bandwidth is a first bandwidth and that has a first quantity of receive antennas is allowed to select or reselect the cell.

Optionally, the first information is carried in a system message.

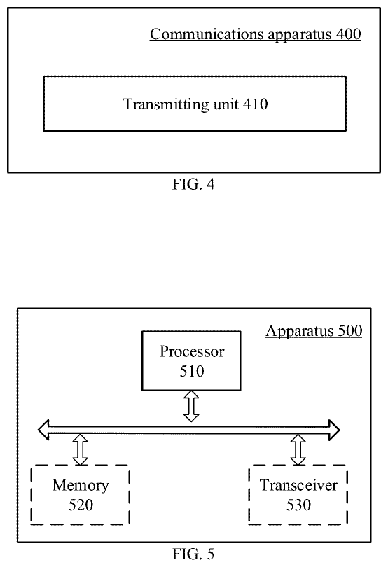

FIG. 4 is a schematic structural diagram of a communications apparatus according to an embodiment of this application. The communications apparatus 400 in FIG. 4 specifically includes:
a transmitting unit 410, configured to transmit first information to a terminal device, where the first information is used to indicate whether a reduced capability RedCap terminal device with a first bandwidth capability is allowed to select or reselect a cell corresponding to the apparatus.

Optionally, the first bandwidth capability includes: A supported maximum bandwidth is a first bandwidth.

Optionally, the first bandwidth capability further includes: a first quantity of receive antennas.

Optionally, the first information is configured to indicate that a RedCap terminal device whose supported maximum bandwidth is a first bandwidth is not allowed to select or reselect the cell.

Optionally, the first information configured to indicate that a RedCap terminal device whose supported maximum bandwidth is a first bandwidth is allowed to select or reselect the cell.

Optionally, the first information is used to indicate that a RedCap terminal device whose supported maximum bandwidth is a first bandwidth and that has a first quantity of receive antennas is not allowed to select or reselect the cell.

Optionally, the first information is used to indicate that a RedCap terminal device whose supported maximum bandwidth is a first bandwidth and that has a first quantity of receive antennas is allowed to select or reselect the cell.

Optionally, the first information is carried in a system message.

FIG. 5 is a schematic structural diagram of an apparatus according to an embodiment of this application. The dashed line in FIG. 5 indicates that the unit or module is optional. The apparatus 500 may be configured to implement the methods described in the foregoing method embodiments. The apparatus 500 may be a chip or a communications apparatus.

The apparatus 500 may include one or more processors 510. The processor 510 may support the apparatus 500 in implementing the methods described in the foregoing method embodiments. The processor 510 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 500 may further include one or more memories 520. The memory 520 stores a program, where the program may be executed by the processor 510, to cause the processor 510 to perform the methods described in the foregoing method embodiments. The memory 520 may be independent of the processor 510 or may be integrated into the processor 510.

The apparatus 500 may further include a transceiver 530. The processor 510 may communicate with another device or chip through the transceiver 530. For example, the processor 510 may transmit data to and receive data from another device or chip through the transceiver 530.

An embodiment of this application further provides a computer-readable storage medium for storing a program. The computer-readable storage medium may be applied to a communications apparatus provided in embodiments of this application, and the program causes a computer to perform the methods to be performed by the communications apparatus in various embodiments of this application.

An embodiment of this application further provides a computer program product. The computer program product includes a program. The computer program product may be applied to a communications apparatus provided in embodiments of this application, and the program causes a computer to perform the methods to be performed by the communications apparatus in various embodiments of this application.

An embodiment of this application further provides a computer program. The computer program may be applied to a communications apparatus provided in embodiments of this application, and the computer program causes a computer to perform the methods to be performed by the communications apparatus in various embodiments of this application.

It should be understood that, in embodiments of this application, “B corresponding to A” means that B is associated with A, and B may be determined based on A. However, it should further be understood that, determining B based on A does not mean determining B based only on A, but instead B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” in the specification generally indicates an “or” relationship between the associated objects.

It should be understood that, in embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented through some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual requirements to achieve the objectives of the solutions of embodiments.

In addition, functional units in embodiments of this application may be integrated into one processing unit, or each of the units may exist alone physically, or two or more units may be integrated into one unit.

All or some of the foregoing embodiments may be implemented through software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
receiving, by a terminal device, first information sent by a network device, wherein the first information is used to indicate whether a reduced capability (RedCap) terminal device with a first bandwidth capability is allowed to select or reselect a cell corresponding to the network device; and
determining, by the terminal device based on the first information, whether to select or reselect the cell.

2. The method according to claim 1, wherein the first bandwidth capability comprises: a supported maximum bandwidth is a first bandwidth.

3. The method according to claim 2, wherein the first bandwidth capability further comprises: a first quantity of receive antennas.

4. The method according to claim 1, wherein the first information is used to indicate that a RedCap terminal device whose supported maximum bandwidth is a first bandwidth is not allowed to select or reselect the cell; or
the first information is used to indicate that a RedCap terminal device whose supported maximum bandwidth is a first bandwidth is allowed to select or reselect the cell.

5. The method according to claim 1, wherein the first information is used to indicate that a RedCap terminal device whose supported maximum bandwidth is a first bandwidth and that has a first quantity of receive antennas is not allowed to select or reselect the cell.

6. The method according to claim 1, wherein the first information is used to indicate that a RedCap terminal device whose supported maximum bandwidth is a first bandwidth and that has a first quantity of receive antennas is allowed to select or reselect the cell.

7. The method according to claim 1, wherein the first information is carried in a system message.

8. A terminal device, comprising:
a processor and a memory, wherein the memory is configured to store a computer program, and the processor is configured to invoke and run the computer program stored in the memory to cause the terminal device to perform:
receiving, first information sent by a network device, wherein the first information is used to indicate whether a reduced capability (RedCap) terminal device with a first bandwidth capability is allowed to select or reselect a cell corresponding to the network device; and
determining, based on the first information, whether to select or reselect the cell.

9. The terminal device according to claim 8, wherein the first bandwidth capability comprises: a supported maximum bandwidth is a first bandwidth.

10. The terminal device according to claim 9, wherein the first bandwidth capability further comprises: a first quantity of receive antennas.

11. The terminal device according to claim 8, wherein the first information is used to indicate that a RedCap terminal device whose supported maximum bandwidth is a first bandwidth and that has a first quantity of receive antennas is not allowed to select or reselect the cell.

12. The terminal device according to claim 8, wherein the first information is used to indicate that a RedCap terminal device whose supported maximum bandwidth is a first bandwidth and that has a first quantity of receive antennas is allowed to select or reselect the cell.

13. The terminal device according to claim 8, wherein the first information is carried in a system message.

14. A communication method, comprising:
sending, by a network device, first information to a terminal device, wherein the first information is used to indicate whether a reduced capability (RedCap) terminal device with a first bandwidth capability is allowed to select or reselect a cell corresponding to the network device.

15. The method according to claim 14, wherein the first bandwidth capability comprises: a supported maximum bandwidth is a first bandwidth.

16. The method according to claim 15, wherein the first bandwidth capability further comprises: a first quantity of receive antennas.

17. The method according to claim 14, wherein the first information is used to indicate that a RedCap terminal device whose supported maximum bandwidth is a first bandwidth and that has a first quantity of receive antennas is not allowed to select or reselect the cell.

18. The method according to claim 14, wherein the first information is used to indicate that a RedCap terminal device whose supported maximum bandwidth is a first bandwidth and that has a first quantity of receive antennas is allowed to select or reselect the cell.

19. The method according to claim 14, wherein the first information is carried in a system message.

20. A network device, comprising a memory, a transceiver, and a processor, wherein the memory is configured to store a program, the processor receives and transmits data through the transceiver, and the processor is configured to invoke the program in the memory, to cause the network device to perform the method according to claim 14.
